(19) United States
(12) Patent Application Publication
(10) Pub. No.: US 2011/0305310 A1
(43) Pub. Date: Dec. 15, 2011

(54) EQUIPMENT AND SYSTEM FOR PROCESSING A GASEOUS MIXTURE BY PERMEATION

(76) Inventors: Jose Gregorio Sanchez, Sussargues (FR); Alejandro Carlos Mourgues Codern, Creusot (FR)

(21) Appl. No.: 12/664,419

(22) PCT Filed: Jun. 9, 2008
(86) PCT No.: PCT/FR2008/051023

§ 371 Date: Apr. 23, 2010

(30) Foreign Application Priority Data
Jun. 14, 2007 (FR) 0755763

(51) Int. Cl. B01D 53/22; G21C 19/303

(52) U.S. Cl. 376/383; 96/9; 95/53; 95/55

(57) ABSTRACT

The invention relates to an equipment and a system for processing a gaseous mixture by permeation. The equipment of the invention includes m*n separation modules Pᵢⱼ, n and n being natural integers higher than or equal to 2, i being a natural integer from 1 to m, and j is a natural interger from 1 to n. Each of the separation modules P₁ includes a permeate inlet Epᵢⱼ, the permeate inlet Ep₁₁ of the separation module P₁₁ corresponding to the F inlet for supplying the gaseous mixture into said equipment, a permeate outlet Spᵢⱼ and a retentate outlet Srᵢⱼ. Furthermore, the permeate outlet Spᵢⱼ is connected to the permeate inlet Epᵢ₊₁ⱼ of the separation module Pⱼ₊₁ⱼ, and the retentate outlet Srᵢⱼ is connected to the permeate inlet Epᵢⱼ₊₁ of the separation module Pᵢⱼ₊₁. The equipment does not use any intermediate recycling.

This invention relates to equipment and a system for processing a gaseous mixture by permeation.

Membrane gas separation is a widely used technique in the chemical industry, developed over the past 25 years. Depending on the nature and structure of the membrane used (polymer, ceramic, dense or porous), different mechanisms are used for transport and separation. Molecular sieving is a technique that consists of separating the gases present in a mixture using the difference in the kinetic radius of the molecules to be separated. For this purpose, a microporous membrane is used, which, based on a difference in the partial pressure or concentration on either side of the membrane, allows the molecules with the smallest kinetic radius to diffuse preferentially and retains the larger molecules. In this way, the membrane is used as a molecular sieve, implementing a pore size exclusion process that inhibits or slows the diffusion of large molecules, thus allowing smaller molecules to be diffused. Also, in some cases, adsorption phenomena (on the surface of the membrane and/or in its pores) may also contribute to the separation. For more information on this technique, refer to “Fundamentals of inorganic membrane science and technology”, A. J. Burggraff and L. Cot, Elsevier, 1996.

The equipment for separating a gaseous mixture by selective permeation is comprised of separation modules that each contain a selectively permeable membrane separating a non-permeate or retentate area and a permeate area. In practice, a separation module usually has several membranes. Note that the geometry of the membranes can also vary. There are basically two types of membranes: flat membranes and tubular membranes. Tubular membranes can be single channel or multichannel membranes (ex. monolith membranes).

The separation module comprises a feed inlet, a retentate outlet, and a permeate outlet.

To separate a gaseous mixture, the separation module is loaded with a flow of the mixture at a pressure P1 by a feed. A difference in pressure is then produced between the two sides of the membrane.

Because the membrane has greater permeability for one constituent of the mixture than for another constituent of the mixture, the permeate is enriched in the more permeable constituent while the other remains on the non-permeate side A retentate with a pressure P1 is recovered from the retentate outlet, and a permeate with a pressure P2, which is less than P1, is recovered from the permeate outlet.

The aforementioned transmembrane gas separation technique proves to be highly advantageous, particularly because it is modular and can be used continuously. In addition, it is a non-polluting technology and allows the construction of compact units. It is an especially attractive alternative to other separation processes, such as cryogenic or adsorption processes, compared to which it is less expensive and simpler to implement. As a result, this technical has many application areas in practice. Among other things, it is used for separating O₂ and N₂ from air, extracting H₂ and N₂ in gases produced from NH₃ or H₂ in hydrocarbon-based effluents, like those from refining processes, or even eliminating CO₂ or NOx in various gaseous effluents.

Moreover, when the conversion rate should be high or when you want to achieve a high concentration factor, it may be advantageous to develop multiple-stage systems, because the filtration rate generally decreases with the concentration of the retentate. Separation is thus achieved over several stages of separation. These configurations help to increase the overall performance of the separation process. In addition, the configuration can help to reduce the total membrane surface, thus reducing the investment cost.

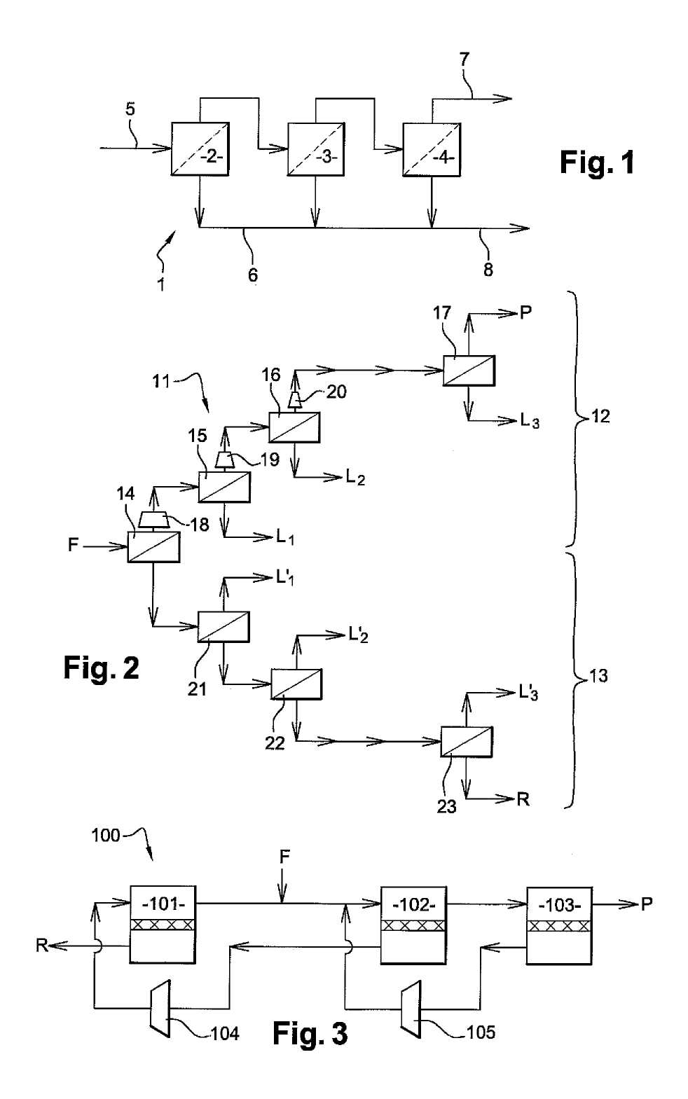

An example multiple-stage configuration is described in patent FR2802114. The principle of this configuration is illustrated in FIG. 1, which shows equipment for processing a gaseous mixture by permeation 1, comprising:
three separation modules 2 to 4 connected in series,
a feed inlet 5,
a retentate outlet 7,
a permeate outlet 8,
a collection line 6.

Each module's retentate outlet is connected to the next module's permeate inlet. The common collection line 6 brings together all of the permeate flows toward the user. The most permeable components are mainly recovered in the permeate, and the least permeable components are recovered in the retentate.

Such a configuration, however, presents a significant problems in that the concentration of impurities in the permeate remains very high. Therefore, when a permeate with the highest possible purity is to be recovered, the configuration according to FIG. 1 is not satisfactory.

Equipment, known as cascade equipment, for increasing the purity of the permeate is discussed in the article “Membrane cascade schemes for separation of LPG olefins and paraffins” (J. Memb. Sci., 233 (2004) 21-37, Avigidou et al.). An example of such equipment 11 is shown schematically in FIG. 2. The equipment 11 is comprised of two parts:
an enrichment part 12,
an extraction part 13,
an inlet separation module 14 with a feed inlet F.

The enrichment part 12 comprised three separation modules 15 to 17 and three compressors 18 to 20.

The extraction part 13 comprises three separation modules 21 to 23.

In the enrichment part 12, the permeate from each separation module is compressed and used to feed the next separation module. This compression is a crucial step for being able to inject the permeate into the next separation module because the permeate output of the permeate has a lower pressure than its inlet pressure.

Also, in the extraction part 13, the retentate coming from each separation module directly feeds the next separation module. The number of steps (three here) in the enrichment part and in the extraction part depends on the desired purity.

However, the implementation of the equipment 11 according to the article “Membrane cascade schemes for separation of LPG olefins and paraffins” presents some problems.

The drawback of this configuration is its relatively low production of pure product. In fact, there is a substantial production of side product that is not used (L₁ to L₃ for the enrichment part and L′₁ to L′₃ for the extraction part). Therefore, the final product, P for the enrichment part 12 and R for the extraction part 13, represents only a small portion of the feed F.

One solution to this problem is to use cascade equipment with recycling, such as the equipment 100 represented schematically in FIG. 3 and discussed in the article “A simplified method for the synthesis of gas separation membrane cascades with limited numbers of compressors” (Chemical Engineering Science, Vol. 52, No. 6 (1997) 1029-1044-R. Agrawal).

The equipment 100 comprises:
an inlet separation module 102 with a main feed inlet F,
two other separation modules 101 and 103,
two compressors 104 and 105.

The retentate outlet from the separation module 102 is connected to the feed inlet on the separation module 103.

The permeate outlet from the separation module 102 is connected to the feed inlet on the separation module 101 via the compressor 104. The retentate outlet from the separation module 103 is connected to the main feed inlet F via the compressor 105.

Therefore, the feed F is divided into only two end products: the permeate P (corresponding to the permeate outlet from the separation module 103) and the retentate R (corresponding to the retentate outlet form the separation module 101).

This equipment helps to increase the production of pure product compared to a cascade configuration without recycling.

However, the implementation of the equipment 100 according to the article “A simplified method for the synthesis of gas separation membrane cascades with limited numbers of compressors” also presents some problems.

In fact, the cost associated with compressors tends to limit the number of the equipment in a commercial application. This is why most commercial applications use only one or two compressors for gas separation.

Also, cascade systems with recycling are usually developed for gaseous concentrations with rather high (>5%) levels of impurity. Thus, cascade systems are not suitable for processing highly diluted impurities (such as vpm up to 2% in volume). Such processing would require very large and powerful compressors, along with several separation steps.

In this context, the present invention aims to provide equipment for processing a gaseous mixture by permeation in order to obtain high-purity products while avoiding loss to side products, said equipment also having a relatively low cost and offering the ability to process gaseous flows with low concentrations of impurities.

For this purpose, the invention proposes equipment for processing a gaseous mixture by permeation comprising m*n separation modules Pᵢⱼ, m and n being natural integers greater than or equal to 2, i being a natural integer from 1 to m, and j being a natural integer from 1 to n, which each separation module Pᵢⱼ comprising:
a permeate inlet Epᵢⱼ, the permeate inlet Ep₁₁ of the separation module P₁₁ corresponding to the equipment's gaseous mixture feed inlet,
a permeate outlet Spᵢⱼ,
a retentate outlet Srᵢⱼ,
   the equipment being characterized in that:
the permeate outlet Spᵢⱼ is connected to the permeate inlet Epᵢ₊₁ⱼ of the separation module Pᵢ₊₁ⱼ,
the retentate outlet Srᵢⱼ is connected to the permeate inlet Epᵢⱼ₊₁ of the separation module Pᵢⱼ₊₁,
   said equipment presenting no intermediate recycling.

The equipment for processing a gaseous mixture can be represented in the form of a matrix with m separation module rows (corresponding to m enrichment steps forming the most permeable by successively going from one permeate outlet to the next permeate inlet) and n separation module columns (corresponding to m enrichment stages forming less permeability by successively going from one retentate outlet to the next permeate inlet).

Note that each separation module can be either a single unit (i.e. with one permeate inlet, one retentate outlet, and one permeate outlet), as described above, or a combination of single modules mounted in parallel (i.e. a feed that splits in order to feed the inlet for each of the single modules and the output for the interconnected single modules).

With the invention, the flow of permeate from a separation module is reused to help feed the separation module in the next step. This allows the components to continue being separated into successive steps without using compressors. In other words, the equipment according to the invention does not require intermediary recycling with compressors between each permeation step. This lack of compressors, of course, creates a significant economic advantage.

Moreover, to purify a gas (i.e. to separate less permeable impurities from the gas), it is desirable for the membrane to have good permselectivity compared to the gas to be purified in order to concentrate the impurities. The number of steps depends on the desired concentration of impurities. That is, the more steps there are, the lower the concentration of impurities in the permeate.

Likewise, the more stages there are, the higher the concentration of impurities in the retentate.

Thus, the number of steps and stages depends on the desired purity (both for the retentate and the permeate) and the quantity of the product to be recovered. The number of steps m may be different than the number of stages n.

This invention also relates to a system for processing a gaseous mixture by permeation comprising at least one piece of equipment according to the invention, the system being represented by a matrix structure Mᵢⱼ with p rows and q columns, comprising p*q elements Mᵢⱼ, i being a natural integer from 1 to p, j being a natural integer from 1 to q, and Mᵢⱼ being either a separation module Pᵢⱼ or an empty element, with each said separation module Pᵢⱼ comprising:
a permeate inlet Epᵢⱼ,
a permeate outlet Spᵢⱼ,
a retentate outlet Srᵢⱼ,
   the permeate outlet Spᵢⱼ being connected to the permeate inlet Epᵢ₊₁ⱼ of the separation module Pᵢ₊₁ⱼ when the separation module exists and said retentate outlet Srᵢⱼ being connected to the permeate inlet Epᵢⱼ₊₁ of the separation module Pᵢⱼ₊₁ when the separation module exists, the element M₁₁ being a non-empty element corresponding to the separation module P₁₁ belonging to at least piece of said equipment, the permeate inlet Ep₁₁ of the separation module P₁₁ corresponding to the gaseous mixture feed inlet in the system.

The system according to the invention may also have one or more of the characteristics below, considered individually or according to all of the technically possible combination:
The various flows of permeate obtained from the system are grouped onto the single permeate outlet row, and/or the various retentate flows obtains from the system are grouped onto a single retentate outlet row.
The system has a compression at the system's gaseous mixture feed inlet.
The separation modules have tubular or multichannel membranes.
The tubular membranes have a silica-based microporous layer with boron.
Each separation module's membrane surface area is adjusted so as to obtain similar concentrations between the retentate flow and the permeate flow that feed into the same next separation module.

This invention also related to use of a system according to the invention for separating helium or hydrogen in gaseous mixtures containing them and nuclear facilities comprising a helium cooling circuit with a processing system according to the invention.

Other characteristics and advantages of the invention will be clear from the description given in the non-exhaustive list of examples below, with reference to the attached figures, among which:

FIG. 1 is a simplified schematic representation of a first piece of equipment for processing a gaseous mixture by permeation according to the prior art;

FIG. 2 is a simplified schematic representation of a second piece of equipment for processing a gaseous mixture by permeation according to the prior art;

FIG. 3 is a simplified schematic representation of a third piece of equipment for processing a gaseous mixture by permeation according to the prior art;

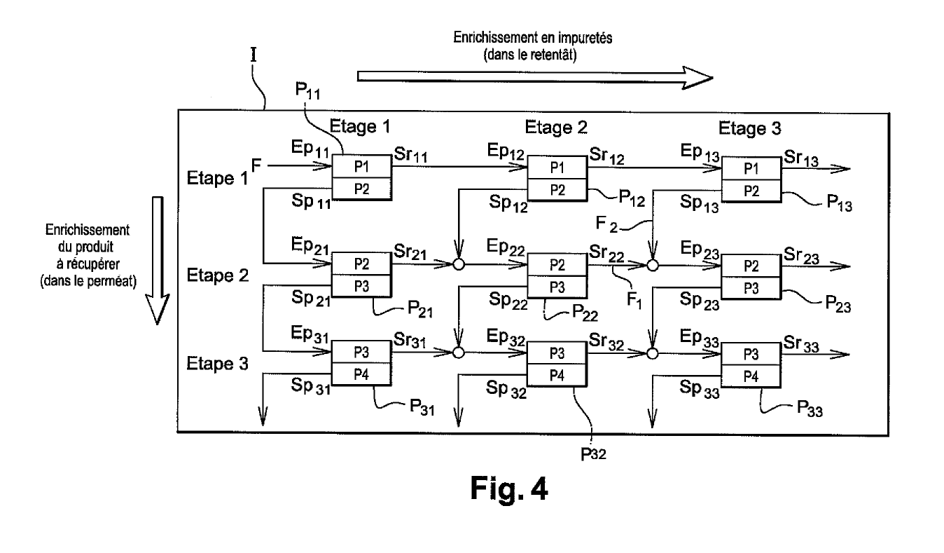

FIG. 4 is a simplified schematic representation of equipment for processing a gaseous mixture according to the invention;

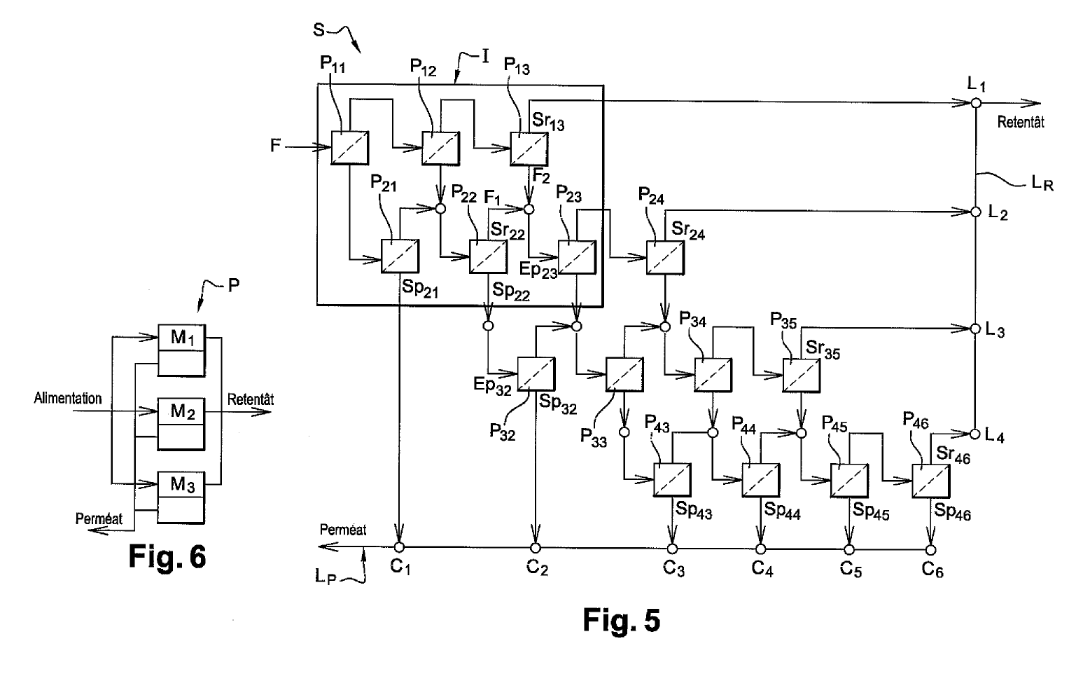

FIG. 5 is a simplified schematic representation of a system for processing a gaseous mixture according to the invention;

FIG. 6 is a simplified schematic representation of a separation module grouping multiple single modules mounted in parallel.

In all of the figures, common elements have the same reference numbers.

FIGS. 1 to 3 were described above in reference to the prior art.

FIG. 4 is a simplified schematic representation of equipment for processing a gaseous mixture according to the invention. The equipment I comprises:
a feed inlet F for the gaseous mixture to be processed,
9 separation modules that can be represented in the form of a matrix (Pᵢⱼ), with l being a natural integer from 1 to 3 and j being a natural integer from 1 to 3.

Each said separation module Pᵢⱼ comprises:
a permeate inlet Epᵢⱼ,
a permeate outlet Spᵢⱼ,
a retentate outlet Srᵢⱼ,

For example, the separation module P₁₂ comprises a permeate inlet Ep₁₂, a permeate outlet Sp₁₂, and a retentate outlet Sr₁₂.

The feed inlet F for the gaseous mixture corresponds to the permeate inlet Ep₁₁ for the separation module P₁₁.

The permeate outlet Spᵢⱼ is connected to the permeate inlet Epᵢ₊₁ⱼ of the separation module Pᵢ₊₁ⱼ This connection corresponds to the movement from step i (row i of the separation module matrix) to step i+1 (row i+1 of the separation module matrix).

The retentate outlet Srᵢⱼ is connected to the permeate inlet Epᵢⱼ₊₁ of the separation module Pᵢⱼ₊₁. This connection corresponds to the movement from stage j (column j of the separation module matrix) to stage j+1 (column j+1 of the separation module matrix).

To separate a gaseous mixture, the separation module P₁₁ is loaded with a flow of the mixture at a pressure P1 by the feed F. A difference in pressure is then produced between the two sides of the membrane.

Because the membrane has greater permeability for one constituent of the mixture than for another constituent of the mixture, the permeate is enriched in the more permeable constituent while the other remains on the non-permeate side. A retentate with a pressure P1 is recovered from the retentate outlet, and a permeate with a pressure P2, which is less than P1, is recovered from the permeate outlet.

The equipment I according to the invention comprises 3 separation module rows (corresponding to 3 enrichment steps forming the most permeable by successively going from one permeate outlet to the next permeate inlet) and 3 separation module columns (corresponding to 3 enrichment stages forming less permeability by successively going from one retentate outlet to the next permeate inlet).

In a particular embodiment, the permeate flows (here, Sp₃₁, Sp₃₂, Sp₃₃) obtained from the output of the equipment I may be grouped onto the same permeate outlet row (not shown in FIG. 4), even if they have different pressures and compositions. The same applies to the retentate flows (here Sr₁₃, Sr₂₃, Sr₃₃) obtains from the output of equipment I, which may be grouped onto a single retentate outlet row.

FIG. 5 shows a system S for processing a gaseous mixture according to the invention.

The system S comprises equipment I similar to that described in reference to FIG. 4 (the only difference residing in the fact that the equipment I in FIG. 5 comprises 2 rows of separation modules and not 3 as is the case for the equipment in FIG. 4).

The system S is presented in the form of a matrix structure (M_{U}) with 4 rows (L1 to L4) and 6 columns (C1 to C6), containing 24 elements M₁₁, with I being a natural integer from 1 to 4 and j being a natural integer from 1 to 6.

An element Mᵢⱼ is either a separation module (as described in reference to FIG. 4) or an empty element.

Thus, for example, M₃₂ is a separation module P₃₂, while M₃₁ is an empty element.

Note that the equipment I in FIG. 4 is a particular case of the system S in which every one of the elements Mᵢⱼ is a separation module (not an empty element).

In the case of FIG. 5, the system S comprises 15 separation modules (rather than the 24 possible):
One row L1: 3 separation modules P₁₁ to P₁₃,
One row L2: 4 separation modules P₂₁ to P₂₄,
One row L3: 4 separation modules P₃₁ to P₃₅,
One row L1: 4 separation modules P₄₁ to P₄₆,

The other elements Mᵢⱼ are empty elements

Generally, the permeate outlet for the separation module Pᵢⱼ is connected to the permeate inlet for the separation module Pᵢ₊₁ⱼ when that separation module exists.

Likewise, the retentate outlet for the separation module Pᵢⱼ is connected to the permeate inlet for the separation module Pᵢⱼ₊₁ when that separation module exists.

Thus, the permeate outlet Sp₂₂ for the separation module P₂₂ is connected to the permeate inlet Ep₃₂ for the separation module P₃₂.

Likewise, the retentate outlet Sr₂₂ for the separation module P₂₂ is connected to the permeate inlet for the separation module P₂₃.

In contrast, the permeate outlet Sp₃₂ for the separation module P₃₂ is not connected to any separation module (M₄₂ is an empty element)

Similarly, the retentate outlet Sr₂₄ for the separation module P₂₄ is not connected to any separation module (M₂₅ is an empty element).

The various permeate flows (here, Sp₂₁, Sp₃₂, Sp₄₃, Sp₄₄, Sp₄₅, and Sp₄₆) obtained from the output of the system S are grouped onto the same permeate outlet row Lp. The same applies to the various retentate flows (here, Sr₁₃, Sr₂₄, Sr₃₅, and Sr₄₆) obtained from the output of the system S, which are grouped onto a single retentate outlet row Lr.

In a preferred embodiment, one can choose the operating conditions (pressure, temperature, flow, and feed composition) and the membrane surface for each separation module in order to obtain similar concentrations between the retentate flows and the permeate flows that feed the same separation module (ex see the concentration of flows F1 and F2, as shown in FIGS. 4 and 5).

In this way, the equipment I and the system S according to the invention form a particularly attractive application in the processing of cooling helium flows, specifically in the primary circuit of new generation high temperature nuclear reactors, called HTRs (“High Temperature Reactors”). In these reactors, impurities, such as CO, CO₂, CH₄, and fission products like Xe or Kr, which are present in helium, must be eliminated, as they are a source of corrosion.

In addition to the specific applications mentioned above, the equipment and the system according to the invention have applications in many areas of use, given their many advantages.

In particular, the equipment and the system according to the invention may be used to extract hydrogen H₂ from gaseous mixtures containing them, like effluents of petrochemical refineries, or to eliminate gaseous pollutants present in the hydrogen flow, such as before its introduction into a synthesis reactor, or even in fuel cells (including PEM, “Proton Exchange Membrane”), where they can eliminate CO gas that can poison catalysts.

Note that membranes with a high separation efficiency in terms of permeance and selectivity are more difficult to obtain the lower the kinetic diameter of the gas to be separated. Therefore, in the applications mentioned above (separation of helium with a kinetic diameter of less than 0.30 nm or hydrogen with a kinetic diameter close to that of helium), separation modules can be used, for example, to group one or more tubular membranes, such as those described in the article “Development of new microporous silica membranes for gas separation” (Barboiu et al., World Hydrogen Energy Conference, Jun. 13-16, 2006, Lyon). These membranes have a silica-based microporous layer with boron.

In an HTR application, the feed pressure P1 is around 70 bars. This pressure is therefore high enough to allow the equipment I to operate without an inlet compressor. All of the output permeate flow will then be reintroduced into the reactor (with a compressor being needed to recirculate the permeate toward the reactor).

In applications with lower pressure feeds, it may be necessary to add a compressor for the feed F.

As we stated in the introduction, cascade systems with recycling are usually developed for gaseous concentrations with rather high (>5%) levels of impurity. Therefore, cascade systems are not suitable for processing highly diluted impurities. In an HTR application, the impurities are highly diluted, around vpm (volume per million). Also, the amount of helium to be recovered must be as high as possible (>99%). The equipment and the system according to the invention are especially well suited for this type of application so as to recover a large amount of helium crossing through the membrane surface to the permeate and to allow for effective filtering, despite highly diluted impurities.

The difference between the equipment I in FIG. 4 and the system S in FIG. 5 is the gradual elimination (in the case of the system 5) of separation modules on the ends (in the lower left and the upper right of the matrix). The main reasons for this elimination are the following:
The separation modules may be eliminated due to the gradual decrease in flow as the number of stages and/or steps increases.
The separation modules may be eliminated because we do not want too large of an increase in the composition of components (in the case of the HTR application, i.e. impurities) in the retentate or too large of an increase of components in the permeate (in the case of the HTR application, the concentration of helium is too high in relation to the need for recirculation toward the reactor, and the concentration of impurities in the recirculated helium is too low).

The fact that the equipment and the system according to the invention do not have intermediate recycling implicitly means that no retentate and permeate outlet from a module in the equipment and system according to the invention is connected to a module before said module in the equipment or in the system. This characteristic is clearly illustrated in FIGS. 4 and 5.

Also, each single unit module Pᵢⱼ, such as represented in FIGS. 4 and 5, can also be a separation module comprising multiple single unit modules mounted in parallel. An example of such a separation module P is shown in FIG. 6. This separation module includes three single unit separation modules M₁ to M₃. The feed is separated into three flows to feed the inlets of each unit module M₁ to M₃. The retentate outlets of modules M₁ to M₃ are interconnected in order to form a general retentate outlet. Similarly, the permeate outlets of modules M₁ to M₃ are interconnected in order to form a general permeate outlet. In order to reduce the speed of the liquid inside the modules and to have properly sized modules when the flow is very high, modules connected in parallel may be used. This makes it possible to decrease the speed of the gas inside the separation modules (and thus the loss of load) and also to work with properly sized modules (separation surface).

Of course, the invention is not limited to the embodiment just described.

In particular, the number of stages and steps in the equipment represented in FIG. 4 is the same, but these may obviously be different.

Also, we have described an example of a tubular membrane, but the invention applies to all types of membranes (flat or tubular membranes, single channel or multichannel membranes) and to all types of separation modules. The same applies to the material used for the membrane, which may be a polymer, mineral, and/or a composite.

Finally, any means may be replaced by an equivalent means.

DRAWINGS

| French | English |
|---|---|
| Enrichissement en impuretés (dans | Enrichment in impurities (in the |
| le retentât) | retentate) |
| Etage 1 | Stage 1 |
| Etage 2 | Stage 2 |
| Etage 3 | Stage 3 |
| Etape 1 | Step 1 |
| Etape 2 | Step 1 |
| Etape 3 | Step 1 |
| Enrichissement du produit à | Enrichment of the product to be |
| récupérer (dans le perméat) | recovered (in the permeate) |
| Retentât | Retentate |
| Perméat | Permeate |
| Alimentation | Feed |

1. A piece of equipment (I) for processing a gaseous mixture by permeation comprising m*n separation modules Pᵢⱼ, m and n being natural integers greater than or equal to 2, i being a natural integer from 1 to m, and j being a natural integer from 1 to n, which each separation module Pᵢⱼ comprising:
a permeate inlet Epᵢⱼ, the permeate inlet Ep₁₁ of the separation module P₁₁ corresponding to the gaseous mixture feed inlet for said equipment (I);
a permeate outlet Spᵢⱼ; and
a retentate outlet Srᵢⱼ;
wherein:
the permeate outlet Spᵢⱼ is connected to the permeate inlet Epᵢ₊₁ⱼ of the separation module Pᵢ₊₁ⱼ; and
the retentate outlet Srᵢⱼ is connected to the permeate inlet Epᵢⱼ₊₁ of the separation module Pᵢⱼ₊₁; and wherein
the piece of equipment presenting no intermediate recycling.

2. A system for processing a gaseous mixture by permeation comprising a piece of equipment according to claim 1, said system being represented by a matrix structure Mᵢⱼ with p rows and q columns, comprising p*q elements Mᵢⱼ, i being a natural integer from 1 to p, j being a natural integer from 1 to q, and Mᵢⱼ being either a separation module Pᵢⱼ or an empty element, with each said separation module Pᵢⱼ comprising:
a permeate inlet Epᵢⱼ;
a permeate outlet Spᵢⱼ; and
a retentate outlet Srᵢⱼ;
the permeate outlet Spᵢⱼ being connected to the permeate inlet Epᵢ₊₁ⱼ of the separation module Pᵢ₊₁ⱼ when the separation module exists and said retentate outlet Srᵢⱼ being connected to the permeate inlet Epᵢⱼ₊₁ of the separation module Pᵢⱼ₊₁ when the separation module exists, the element M₁₁ being a non-empty element corresponding to the separation module P₁₁ belonging to at least piece of said equipment, the permeate inlet Ep₁₁ of the separation module P₁₁ corresponding to the gaseous mixture feed inlet (E) in said system.

3. A system according to claim 2, wherein the various permeate flows (Sp₂₁, Sp₃₂, Sp₄₃, Sp₄₄, Sp₄₅, and Sp₄₆) obtained from the output of said system are grouped onto the same permeate outlet row (Lp) and/or the various retentate flows (Sr₁₃, Sr₂₄, Sr₃₅, and Sr₄₆) obtained from the output of the system, which are grouped onto a single retentate outlet row (Lr).

4. A system according to claim 2, wherein it comprises a compressor at the gaseous mixture feed inlet (F) for said system.

5. A system according to claim 2, wherein said separation modules include tubular membranes.

6. A system according to claim 2, wherein said separation modules include multichannel membranes.

7. A system according to claim 5, wherein said membranes have a silica-based microporous layer with boron.

8. A system according to claim 2, wherein each separation module's membrane surface area is adjusted so as to obtain similar concentrations between the retentate flow and the permeate flow that feed into the same separation module.

9. A system according to claim 2, wherein at least one of the separation modules has multiple single unit separation modules mounted in parallel.

10. A use of a system according to claim 2 for separating helium or hydrogen in gaseous mixtures containing them.

11. A nuclear facility comprising a helium cooling circuit with a processing system according to claim 2.
